(19) United States
(12) Patent Application Publication
(10) Pub. No.: US 2010/0275741 A1
(43) Pub. Date: Nov. 4, 2010

(54) BIT HAVING AN IDENTIFICATION FUNCTION

(76) Inventor: Jin-Tsai Lai, Taichung City (TW)

Correspondence Address: Chien-Hui Su, P. O. Box 70-121 Taichung, Taichung City, 40899, TW

(21) Appl. No.: 12/432,709

(22) Filed: Apr. 29, 2009

(51) Int. Cl. B25B 23/00

(52) U.S. Cl. 81/438; 81/180.1

(57) ABSTRACT

A bit having an identification function includes a head portion for driving a fastener and a shank portion connected to the head portion. The shank portion has a first recess defined therein. The shank portion has a first recognition portion formed in the first recess and made of plastic injection molding. The shank portion has a second recess formed in the outer peripheral of the first recognition portion. The shank portion has a second recognition portion formed in the second recess and made of plastic injection molding. The second recognition portion has an identification portion defined therein and being concave. The first recognition portion, the second recognition portion, and the identification portion provide the identification function.

### BACKGROUND OF THE INVENTION

1. Field of the Invention

The present invention relates to a hand tool, and more particularly to a bit having an identification function.

2. Description of Related Art

A conventional bit in accordance with the prior art comprises a driving head and a connecting portion connected to the driving head. The driving head is used to drive a screw. The connecting portion is used to be connected to a hand tool or a pneumatic tool. The connecting portion has a mark to identify the specification of the bit. The conventional bit is made of metal. The depth of the mark is quite shallow. After a period of usage, the mark is worn such the bit has no identification function.

Another conventional bit in accordance with the prior art comprises a color band sleeved on the bit. The different color band provides an identification function. When there are numerous conventional bits in a toolbox, the single color identification is not enough to find the specific bit.

The present invention has arisen to mitigate and/or obviate the disadvantages of the conventional bit.

### SUMMARY OF THE INVENTION

The main objective of the present invention is to provide an improved bit having an identification function.

To achieve the objective, the bit having an identification function includes a head portion for driving a fastener and a shank portion connected to the head portion. The shank portion has a first recess defined therein. The shank portion has a first recognition portion formed in the first recess and made of plastic injection molding. The shank portion has a second recess formed in the outer peripheral of the first recognition portion. The shank portion has a second recognition portion formed in the second recess and made of plastic injection molding. The second recognition portion has an identification portion defined therein and being concave. The first recognition portion, the second recognition portion, and the identification portion provide the identification function.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a bit having an identification function in accordance with the present invention;

FIG. 2 is a partial enlarged cross-sectional view of the bit taken along line A-A in FIG. 1;

FIG. 3 is a front elevational view of the bit having an identification function in accordance with the present invention;

FIG. 4 is a perspective view of a second embodiment of a bit having an identification function in accordance with the present invention;

FIG. 5 is a partial enlarged perspective view of the bit in FIG. 4; and

FIG. 6 is a perspective view of a third embodiment of a bit having an identification function in accordance with the present invention.

### DETAILED DESCRIPTION OF THE INVENTION

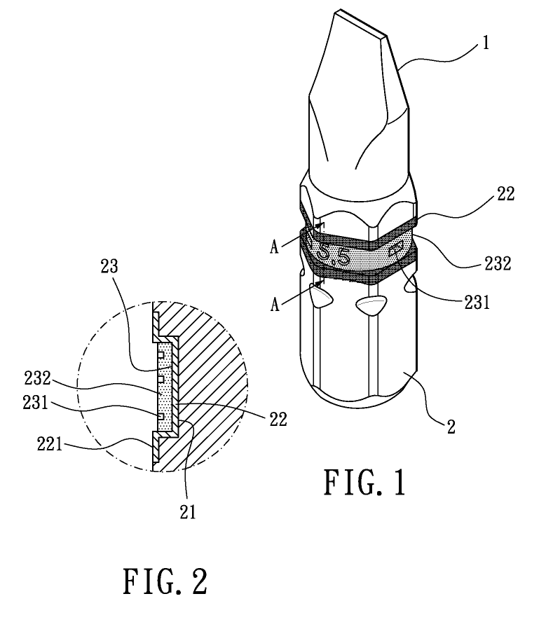

Referring to the drawings and initially to FIGS. 1-3, a bit having an identification function in accordance with the present invention comprises a head portion 1 and a shank portion 2 connected to the head portion 1. The shank portion 2 has a section of hexagon to adapt to a pneumatic tool, a power tool, or a tool handle.

The head portion 1 is provided for driving a fastener, i.e. screw. The head portion 1 of the first embodiment is a flat blade type driver to drive a flat slot type fastener. The head portion 1 is disposed in one end of the bit. The shank portion 2 is disposed in the other end of the bit. The shank portion 2 is longer than the head portion 1. The shank portion 2 has a first recess 21 defined therein. The first recess 21 is annularly disposed in a middle of the bit. The first recess 21 is a stepped recess and has an appropriate depth to prevent from reducing the strength of the bit. The bit further comprises a first recognition portion 22 annularly formed in the first recess 21. The first recognition portion 22 is made by plastic injection molding and has a uniform thickness to wrap the first recess 21. The first recognition 22 has two wings 221 respectively formed in two ends thereof. Each wing 221 is flushed with an outer peripheral of the shank portion 2 to prevent from wearing. Each wing 221 is revealed to provide an identification effort.

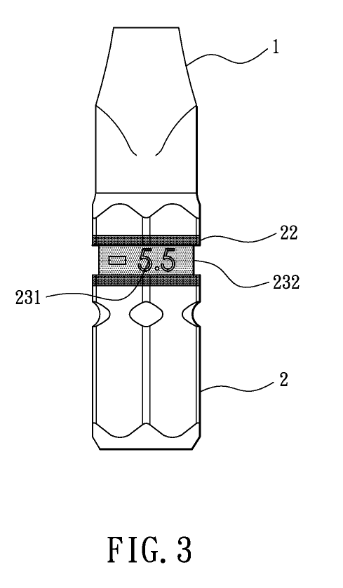

The shank portion 2 has a second recess 23 defined in therein. The second recess 23 is annularly formed in an outer peripheral of the first recognition portion 22. The bit further comprises a second recognition portion 232 annularly formed in the second recess 23. The second recognition portion 232 is made by plastic injection molding and has a uniform thickness to wrap the second recess 23. A thickness of the second recognition portion 232 is less than a depth of the second recess 23 to prevent from wearing. The second recognition portion 232 further comprises an identification portion 231 formed therein. The identification portion 231 is a concave mark i.e. character or pattern as shown in FIGS. 1 and 3. The character “5.5” means the size of the head portion 1 is 5.5. The pattern “-” means the type of the head portion 1 is flat blade type. The first recognition portion 22 and the second recognition portion 232 are different colors such that the different colors are provided to identify the size and type of the head portion 1. In this embodiment, the color of the first recognition portion 22 is provided to identify the size of the head portion 1. The color of the second recognition portion 232 is provided to identify the type of the head portion. In other embodiment, the color of the first recognition portion 22 is provided to identify the type of the head portion 1. The color of the second recognition portion 232 is provided to identify the size of the head portion 1. When users forget the meaning of the colors, they use the character or pattern of the identification portion 231 to identify the bit. The identification portion 231 is concave to prevent from wearing and increase the usage lifetime.

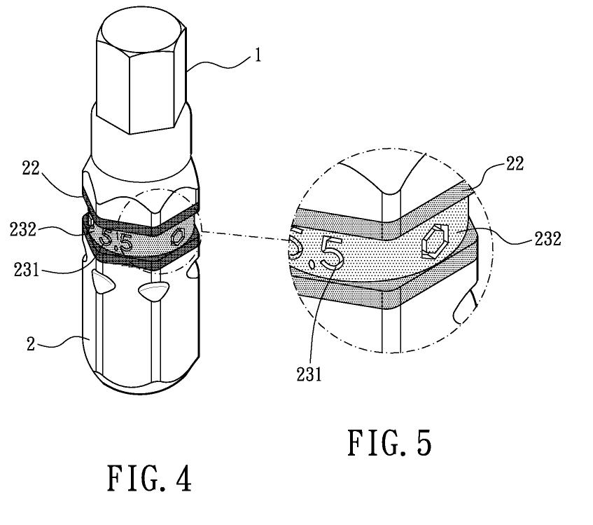

Referring to FIGS. 4-5, a second embodiment of a bit in accordance with the present invention is illustrated. The elements and the efforts which are the same with the first embodiment are not described, only the differences are described. The character of the identification portion 231 means the size of the head portion 1 is 5.5. The pattern of the identification portion 231 means the type of the head portion 1 is hexagon type.

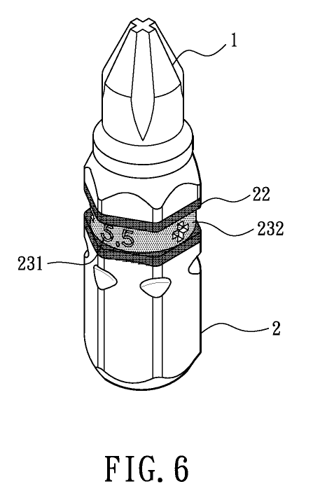

Referring to FIG. 6, a third embodiment of a bit in accordance with the present invention is illustrated. The elements and the efforts which are the same with the first embodiment are not described, only the differences are described. The character of the identification portion 231 means the size of the head portion 1 is 5.5. The pattern of the identification portion 231 means the type of the head portion 1 is Phillips type.

Although the invention has been explained in relation to its preferred embodiment, it is to be understood that many other possible modifications and variations can be made without departing from the spirit and scope of the invention as hereinafter claimed.

What is claimed is:

1. A bit having an identification function comprising:
a head portion for driving a fastener; and
a shank portion connected to the head portion, the shank portion having a first recess defined therein, the shank portion having a first recognition portion formed in the first recess and made of plastic injection molding, the shank portion having a second recess formed in the outer peripheral of the first recognition portion, the shank portion having a second recognition portion formed in the second recess and made of plastic injection molding, the second recognition portion having an identification portion defined therein and being concave, wherein the first recognition portion, the second recognition portion, and the identification portion provide the identification function.

2. The bit having an identification function as claimed in claim 1, wherein the identification portion is a concave character to identify a size of the head portion.

3. The bit having an identification function as claimed in claim 1, wherein the identification portion is a concave pattern to identify a type of the head portion.

4. The bit having an identification function as claimed in claim 1, wherein the first recess is an annular stepped recess.

5. The bit having an identification function as claimed in claim 1, wherein the second recess is an annular recess.

6. The bit having an identification function as claimed in claim 1, wherein the first recognition portion and the second recognition portion are different colors.

7. The bit having an identification function as claimed in claim 6, wherein the first recognition portion is provided to identify a size of the head portion; the second recognition portion is provided to identify a type of the head portion.

8. The bit having an identification function as claimed in claim 6, wherein the first recognition portion is provided to identify a type of the head portion; the second recognition portion is provided to identify a size of the head portion.

9. The bit having an identification function as claimed in claim 1, wherein the shank portion is longer than the head portion.

10. The bit having an identification function as claimed in claim 1, wherein a thickness of the second recognition portion is less than a depth of the second recess.
